(19) United States
(12) Patent Application Publication
(10) Pub. No.: US 2014/0052577 A1
(43) Pub. Date: Feb. 20, 2014

(54) SYSTEM AND METHOD FOR TRAVEL AND PLANNING AND TRIP INFORMATION AGGREGATION

(71) Applicants: Stephen GOTLIEB, Los Altos, CA (US); Eugene MIRKIN, San Francisco, CA (US); Timothy O'NEIL-DUNNE, Redmond, WA (US); Paul ADDY, Greater Manchester (GB); Ashley Lowe RAITERI, Portland, OR (US)

(72) Inventors: Stephen GOTLIEB, Los Altos, CA (US); Eugene MIRKIN, San Francisco, CA (US); Timothy O'NEIL-DUNNE, Redmond, WA (US); Paul ADDY, Greater Manchester (GB); Ashley Lowe RAITERI, Portland, OR (US)

(21) Appl. No.: 13/910,965

(22) Filed: Jun. 5, 2013

Related U.S. Application Data
(60) Provisional application No. 61/656,294, filed on Jun. 6, 2012.

(51) Int. Cl. G06Q 30/06

(52) U.S. Cl. CPC G06Q 30/0619
USPC 705/26.44

(57) ABSTRACT

The present disclosure relates generally to coordinating travel plans in a networked environmental. More particularly, the disclosure relates to providing a dashboard of aggregated travel information.

### CROSS-REFERENCE

This application claims the benefit of U.S. Provisional Application No. 61/656,294, filed Jun. 6, 2012, which application is incorporated herein by reference.

### BACKGROUND OF THE INVENTION

The present disclosure relates generally to plan and coordinating travel in an individual or in a networked environmental. More particularly, the disclosure relates to providing a dashboard of aggregated travel information.

Other solutions include, for example, those disclosed in US 2009/0012824 A1 to Brockway et al. for Apparatus and Method for Supplying An Aggregated and Enhanced Itinerary, published Jan. 8, 2009. Brockway discloses a computer readable storage medium that supplies an aggregated and enhanced itinerary.

### SUMMARY OF THE INVENTION

Disclosed is an application that enables consumers to simplify their travel planning. The application is a travel planning platform The travel planning platform an, for example, organize information within a securely accessed dashboard which then organizes travel products (e.g., arrangements for airline, hotel, rental car, etc.) within tripboard. The travel planning platform enables consumers and/or travel agents and/or travel planners to aggregate and organize (pin or mark) specific travel products from any third party travel site and/or database into one location. In a user's tripboard within their password protected dashboard, the users are able to make a side-by-side comparison of a plurality of pinned travel products. The platform is also configurable such that it can display other relevant information and travel products to the travelers/users that might not have been available from the original source. The user will be able to manage all the different pinned or marked travel products within their trip/s view or on a tripboard or within the dashboard, primary website or travel product aggregation platform. Management actions include, for example, adding more travel products, deleting travel products, making changes to trip parameters, inviting users, chatting, price change alerts, etc. Additionally, users are able to create multiple trips at any time and manage them. The platform will also update the price point of all the travel products so that the tripboard reflects the current market situation. Through the platform, users will be able to invite other users and/or guests to view and interact with the specific trip they have been invited to. The users will also be able to manage all of their connections and/or synchronize, or selectively synchronize, connections with other sources (e.g., Outlook or Facebook). Users also will be able to communicate on the tripboard and/or dashboard thru, for example, a chat box. The platform also allows for third party companies to promote deals, promotions, and/or ancillary travel products directly to the consumers who will most benefit from, or be interested in, those promotions. The system can also recommend any travel products that might be relevant and has not been pinned into the tripboard. Finally the platform is configurable to have live links to all third party websites that offer the specific travel products, this enables the users to easily complete the purchase.

The platform has access to the travel products that users are interested in and therefore is able to offer to the travel providers a mechanism to match their supply with the market's demand. Users who bookmark options that they are interested in and follow through time and price changes provide the platform with information that enables computation of what the market demand is for specific travel products and/pr for specific users. With that computation, the platform will be able to provide the travel suppliers through several channels to match their supply with the market demand. The matching will not only occur in regards to price, but also in regards to destination, schedules, provider, and others. On the other side the platform will enable the suppliers to provide users with specific items and understand the immediate reaction on the demand side of the perceived value of the item.

An aspect of the disclosure is directed to a computer-readable medium having computer executable instructions comprising: collecting from a computing device one or more primary parameters; generating a search result on a third party platform which provides one or more results which contain the one or more primary parameters collected, generating a visual marker within the third party platform at each of the one or more search results wherein the visual marker is capable of communicating with the tripboard; receiving a selection of one or more results from the third party website wherein the one or more selected results is accessible by the computing device; and creating a category accessible by the computing device in response to the one or more selected results. In some configurations, the system is configurable to provide one or more of each of: refreshing a time variable parameter of the one or more selected results when the category is accessed from the computing device, such as by communicating one or more refreshed results to another user having access to the category; from the third party website accessing a subsequent third party website and generating a subsequent search result from the one or more primary parameters without collecting additional parameters; generating one or more targeted advertisements within a category based on the one or more parameters of the selected items within the category; determining whether a plugin has been installed on the computing device, and then prompting a user to install the plugin if a plugin has not been installed; requesting a secondary user to access the category accessible via the computing device wherein the category has one or more selected items; purchasing an item from a third party website; providing one or more non-pinned travel products which include the one or more primary parameters; and at least one of sorting and filtering the selection of one or more results from the third party websites by one or more of price, date, carrier, destination, and availability.

Additionally, one or more of a category and the selected items, such as within the tripboard, can a comment section or communication, real-time or delayed, functionality. Communication and commenting can be between two or more users having access to a category or tripboard. In some instances communication and/or commenting can be maintained as private between two users, if desired, such that the communication and/or commenting is not available to other users having access to the category. During the purchasing process, users can purchase one of the marked items in the category, or an item having one or more of the primary parameters that may or may not be pinned or marked in the category. Primary parameters are selected from the group comprising: origination location, destination location, date (or date ranges or parameters), user preferences, price parameter, and target third party website.

An additional aspect of the disclosure is directed to a method of organizing trip itineraries from a plurality of third party websites comprising: collecting from a computing device one or more primary parameters; generating a search result on a third party website which provides one or more results which contain the one or more primary parameters collected, generating a visual marker within the third party website at each of the one or more search results wherein the visual marker is capable of communicating with the dashboard installed on the computing device; receiving a selection of one or more results from the third party website wherein the one or more selected results is accessible by the computing device; and creating a category accessible by the computing device in response to the one or more selected results. In some configurations, the system is configurable to provide one or more of each of: refreshing a time variable parameter of the one or more selected results when the category is accessed from the computing device, such as by communicating one or more refreshed results to another user having access to the category; from the third party website accessing a subsequent third party website and generating a subsequent search result from the one or more primary parameters without collecting additional parameters; generating one or more targeted advertisements within a category based on the one or more parameters of the selected items within the category; determining whether a plugin has been installed on the computing device, and then prompting a user to install the plugin if a plugin has not been installed; requesting a secondary user to access the category accessible via the computing device wherein the category has one or more selected items; purchasing an item from a third party website; providing one or more non-pinned travel products which include the one or more primary parameters; and at least one of sorting and filtering the selection of one or more results from the third party websites by one or more of price, date, carrier, destination, and availability. Additionally, one or more of a category and the selected items, such as within the tripboard, can a comment section or communication, real-time or delayed, functionality. Communication and commenting can be between two or more users having access to a category or tripboard. In some instances communication and/or commenting can be maintained as private between two users, if desired, such that the communication and/or commenting is not available to other users having access to the category. During the purchasing process, users can purchase one of the marked items in the category, or an item having one or more of the primary parameters that may or may not be pinned or marked in the category. Primary parameters are selected from the group comprising: origination location, destination location, date (or date ranges or parameters), user preferences, price parameter, and target third party website.

Still another aspect of the disclosure is directed to a computing device comprising: a processor; a storage medium for tangibly storing thereon program logic for execution by the processor, the program logic comprising: collecting from a computing device one or more primary parameters; generating a search result on a third party website which provides one or more results which contain the one or more primary parameters collected, generating a visual marker within the third party website at each of the one or more search results wherein the visual marker is capable of communicating with the dashboard installed on the computing device; receiving a selection of one or more results from the third party website wherein the one or more selected results is accessible by the computing device; and creating a category accessible by the computing device in response to the one or more selected results. In some configurations, the system is configurable to provide one or more of each of: refreshing a time variable parameter of the one or more selected results when the category is accessed from the computing device, such as by communicating one or more refreshed results to another user having access to the category; from the third party website accessing a subsequent third party website and generating a subsequent search result from the one or more primary parameters without collecting additional parameters; generating one or more targeted advertisements within a category based on the one or more parameters of the selected items within the category; determining whether a plugin has been installed on the computing device, and then prompting a user to install the plugin if a plugin has not been installed; requesting a secondary user to access the category accessible via the computing device wherein the category has one or more selected items; purchasing an item from a third party website; providing one or more non-pinned travel products which include the one or more primary parameters; and at least one of sorting and filtering the selection of one or more results from the third party websites by one or more of price, date, carrier, destination, and availability. Additionally, one or more of a category and the selected items, such as within the tripboard, can a comment section or communication, real-time or delayed, functionality. Communication and commenting can be between two or more users having access to a category or tripboard. In some instances communication and/or commenting can be maintained as private between two users, if desired, such that the communication and/or commenting is not available to other users having access to the category. During the purchasing process, users can purchase one of the marked items in the category, or an item having one or more of the primary parameters that may or may not be pinned or marked in the category. Primary parameters are selected from the group comprising: origination location, destination location, date (or date ranges or parameters), user preferences, price parameter, and target third party website.

Yet another aspect of the disclosure is directed to a method of providing demand data comprising: collecting from one or more computing devices one or more primary parameters; generating one or more search results on one or more third party websites which provide one or more selectable items which contain the one or more primary parameters collected; receiving a selection by one or more users of one or selectable items from the search results; aggregating the one or more selectable items for the one or more users; and determining a demand for one or more selectable items. Additionally, the step of determining demand can further comprise, in some circumstances, receiving and analyzing user response to a price change, analyzing user comments within a tripboard, and/or predicting demand for a travel product.

An aspect of the disclosure is directed to a computer-readable medium having computer executable instructions comprising: collecting from one or more computing devices one or more primary parameters; generating one or more search results on one or more third party websites which provide one or more selectable items which contain the one or more primary parameters collected; receiving a selection by one or more users of one or selectable items from the search results; aggregating the one or more selectable items for the one or more users; and determining a demand for one or more selectable items. Additionally, the step of determining demand can further comprise, in some circumstances, receiving and analyzing user response to a price change, analyzing user comments within a tripboard, and/or predicting demand for a travel product. Still another aspect of the disclosure is directed to a computing device comprising: a processor; a storage medium for tangibly storing thereon program logic for execution by the processor, the program logic comprising: collecting from one or more computing devices one or more primary parameters; generating one or more search results on one or more third party websites which provide one or more selectable items which contain the one or more primary parameters collected; receiving a selection by one or more users of one or selectable items from the search results; aggregating the one or more selectable items for the one or more users; and determining a demand for one or more selectable items. Additionally, the step of determining demand can further comprise, in some circumstances, receiving and analyzing user response to a price change, analyzing user comments within a tripboard, and/or predicting demand for a travel product.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A is a block diagram showing a representative example of a logic device through which trip planning and management can be achieved;

FIG. 1B is a block diagram of an exemplary computing environment through which trip planning and management can be achieved;

FIG. 1C is an illustrative architectural diagram showing some structure that can be employed by devices through which trip planning and management is achieved;

FIG. 2 is an exemplary diagram of a server in an implementation suitable for use in a system where trip planning and management is achieved;

FIG. 3 is an exemplary diagram of a master system in an implementation suitable for use in a system where trip planning and management is achieved;

FIG. 4 is a block diagram showing the cooperation of exemplary components of a system suitable for use in a system where trip planning and management is achieved;

FIGS. 5A-C illustrate processes for pinning travel products;

FIGS. 6A-C illustrates exemplar screen shots of the pinning process;

FIGS. 7A-C illustrate processes refreshing prices for pinned travel products reflecting the last price, sharing trip plans, and ranking and commenting on shared trips with other users;

FIG. 8A-B are exemplar screen shots illustrating the price updating interface;

FIG. 9 illustrates a process for communicating updated price information for pinned travel products to users;

FIG. 10 illustrates a process for launching a dashboard, refreshing prices, and providing relevant advertisements; and

FIG. 11 illustrates a screen shot of pinned travel products with relevant advertisements.

### DETAILED DESCRIPTION OF THE INVENTION

### I. Computing Systems

The systems and methods described herein rely on a variety of computer systems, networks and/or digital devices for operation. In order to fully appreciate how the system operates an understanding of suitable computing systems is useful. The systems and methods disclosed herein are enabled as a result of application via a suitable computing system.

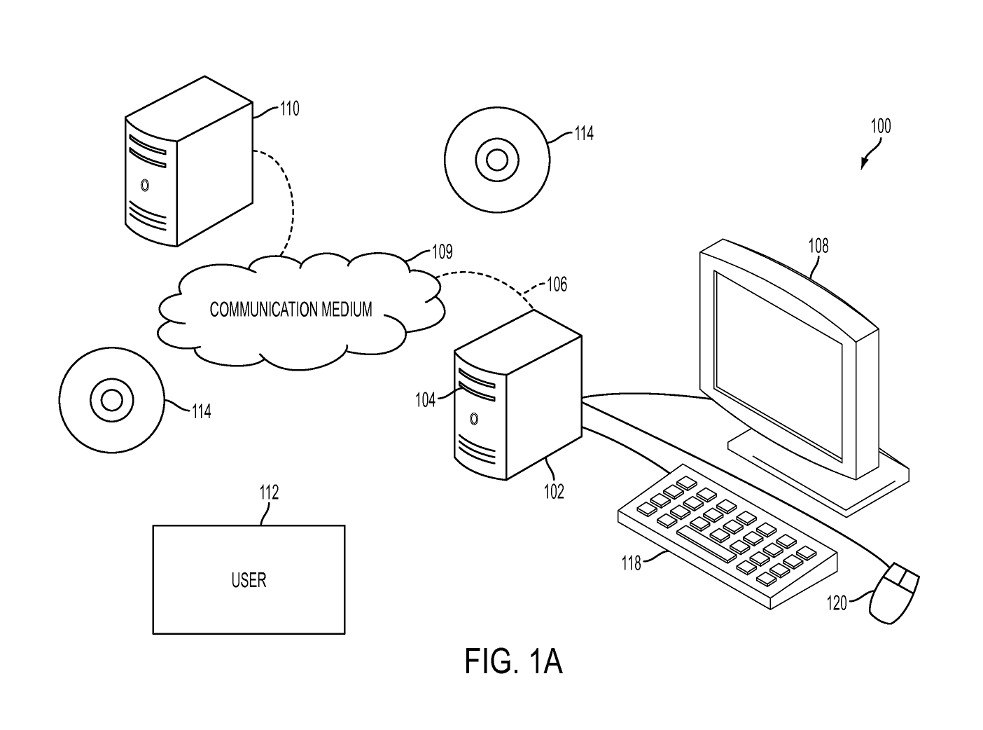

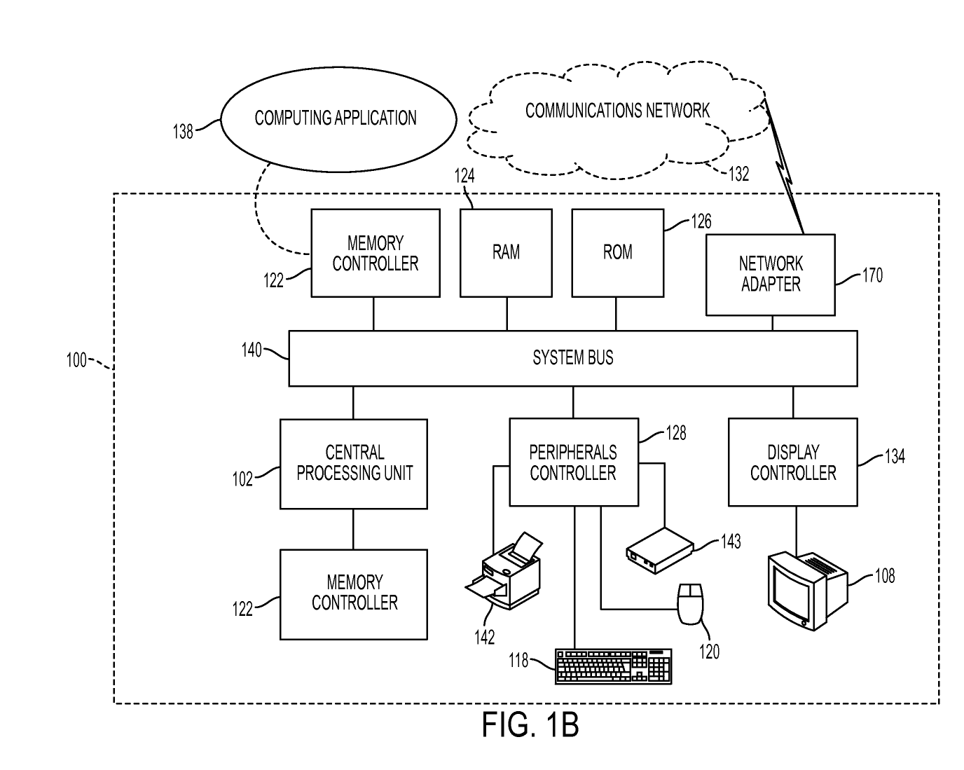

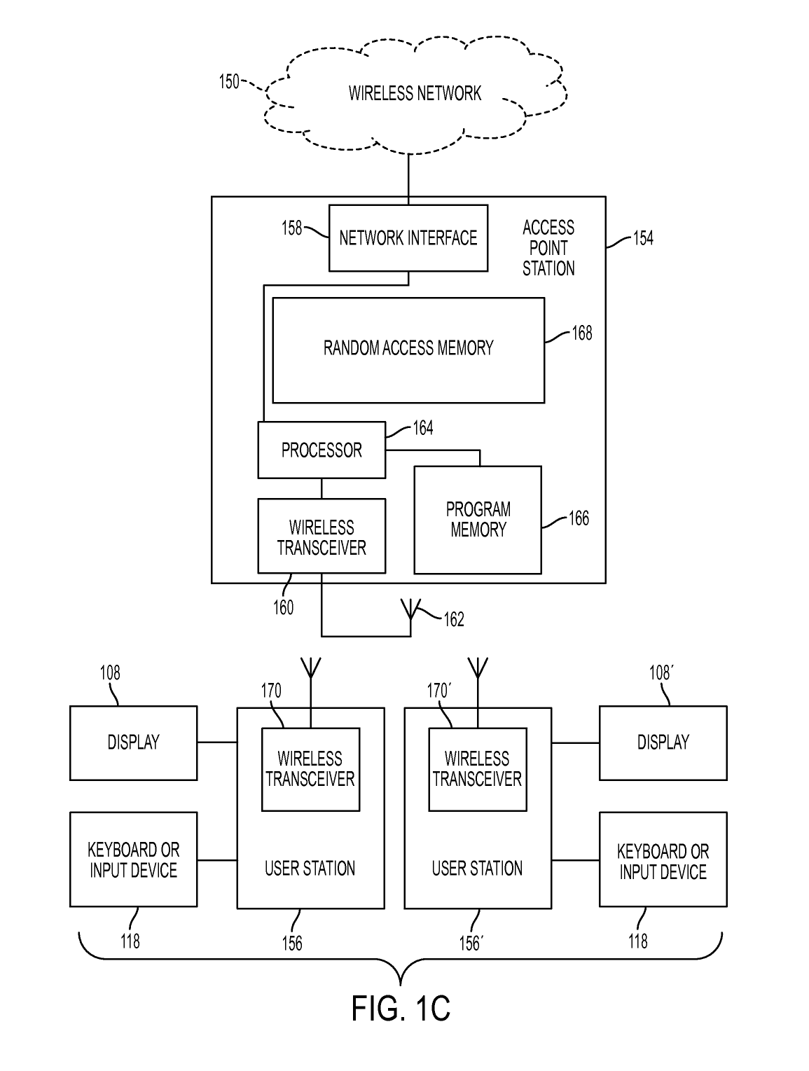

FIG. 1A is a block diagram showing a representative example logic device through which a browser can be accessed to implement the present invention. A computer system (or digital device) 100, which may be understood as a logic apparatus adapted and configured to read instructions from media 114 and/or network port 106, is connectable to a server 110, and has a fixed media 116. The computer system 100 can also be connected to the Internet or an intranet. The system includes central processing unit (CPU) 102, disk drives 104, optional input devices, illustrated as keyboard 118 and/or mouse 120 and optional monitor 108. Data communication can be achieved through, for example, communication medium 109 to a server 110 at a local or a remote location. The communication medium 109 can include any suitable means of transmitting and/or receiving data. For example, the communication medium can be a network connection, a wireless connection or an internet connection. It is envisioned that data relating to the present invention can be transmitted over such networks or connections. The computer system can be adapted to communicate with a participant and/or a device used by a participant. The computer system is adaptable to communicate with other computers over the Internet, or with computers via a server.

FIG. 1B depicts another exemplary computing system 100. The computing system 100 is capable of executing a variety of computing applications 138, including computing applications, a computing applet, a computing program, or other instructions for operating on computing system 100 to perform at least one function, operation, and/or procedure. Computing system 100 is controllable by computer readable storage media for tangibly storing computer readable instructions, which may be in the form of software. The computer readable storage media adapted to tangibly store computer readable instructions can contain instructions for computing system 100 for storing and accessing the computer readable storage media to read the instructions stored thereon themselves. Such software may be executed within CPU 102 to cause the computing system 100 to perform desired functions. In many known computer servers, workstations and personal computers CPU 102 is implemented by micro-electronic chips CPUs called microprocessors. Optionally, a co-processor, distinct from the main CPU 102, can be provided that performs additional functions or assists the CPU 102. The CPU 102 may be connected to co-processor through an interconnect. One common type of coprocessor is the floating-point coprocessor, also called a numeric or math coprocessor, which is designed to perform numeric calculations faster and better than the general-purpose CPU 102.

As will be appreciated by those skilled in the art, a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor

In operation, the CPU 102 fetches, decodes, and executes instructions, and transfers information to and from other resources via the computer's main data-transfer path, system bus 140. Such a system bus connects the components in the computing system 100 and defines the medium for data exchange. Memory devices coupled to the system bus 140 include random access memory (RAM) 124 and read only memory (ROM) 126. Such memories include circuitry that allows information to be stored and retrieved. The ROMs 126 generally contain stored data that cannot be modified. Data stored in the RAM 124 can be read or changed by CPU 102 or other hardware devices. Access to the RAM 124 and/or ROM 126 may be controlled by memory controller 122. The memory controller 122 may provide an address translation function that translates virtual addresses into physical addresses as instructions are executed.

In addition, the computing system 100 can contain peripherals controller 128 responsible for communicating instructions from the CPU 102 to peripherals, such as, printer 142, keyboard 118, mouse 120, and data storage drive 143. Display 108, which is controlled by a display controller 163, is used to display visual output generated by the computing system 100. Such visual output may include text, graphics, animated graphics, and video. The display controller 134 includes electronic components required to generate a video signal that is sent to display 108. Further, the computing system 100 can contain network adaptor 136 which may be used to connect the computing system 100 to an external communications network 132.

### II. Networks and Internet Protocol

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

### III. Wireless Networks

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. In this document, the terminology “node” includes a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

FIG. 1C depicts components that can be employed in system configurations enabling the systems and technical effect of this invention, including wireless access points to which client devices communicate. In this regard, FIG. 1C shows a wireless network 150 connected to a wireless local area network (WLAN) 152. The WLAN 152 includes an access point (AP) 154 and a number of user stations 156, 156′. For example, the network 150 can include the Internet or a corporate data processing network. The access point 154 can be a wireless router, and the user stations 156, 156′ can be portable computers, personal desk-top computers, PDAs, portable voice-over-IP telephones and/or other devices. The access point 154 has a network interface 158 linked to the network 150, and a wireless transceiver in communication with the user stations 156, 156′. For example, the wireless transceiver 160 can include an antenna 162 for radio or microwave frequency communication with the user stations 156, 156′. The access point 154 also has a processor 164, a program memory 166, and a random access memory 168. The user station 156 has a wireless transceiver 170 including an antenna 172 for communication with the access point station 154. In a similar fashion, the user station 156′ has a wireless transceiver 170′ and an antenna 172 for communication to the access point 154. By way of example, in some embodiments an authenticator could be employed within such an access point (AP) and/or a supplicant or peer could be employed within a mobile node or user station. Desktop 108 and key board 118 or input devices can also be provided with the user status.

### IV. Media Independent Handover Services

In IEEE P802.21/D.01.09, September 2006, entitled Draft IEEE Standard for Local and Metropolitan Area Networks: Media Independent Handover Services, among other things, the document specifies 802 media access-independent mechanisms that optimize handovers between 802 systems and cellular systems. The IEEE 802.21 standard defines extensible media access independent mechanisms that enable the optimization of handovers between heterogeneous 802 systems and may facilitate handovers between 802 systems and cellular systems. “The scope of the IEEE 802.21 (Media Independent Handover) standard is to develop a specification that provides link layer intelligence and other related network information to upper layers to optimize handovers between heterogeneous media. This includes links specified by 3GPP, 3GPP2 and both wired and wireless media in the IEEE 802 family of standards. Note, in this document, unless otherwise noted, “media” refers to method/mode of accessing a telecommunication system (e.g. cable, radio, satellite, etc.), as opposed to sensory aspects of communication (e.g. audio, video, etc.).” See 1.1 of I.E.E.E. P802.21/D.01.09, September 2006, entitled Draft IEEE Standard for Local and Metropolitan Area Networks: Media Independent Handover Services, the entire contents of which document is incorporated herein into and as part of this patent application. Other IEEE, or other such standards on protocols can be relied on as appropriate or desirable.

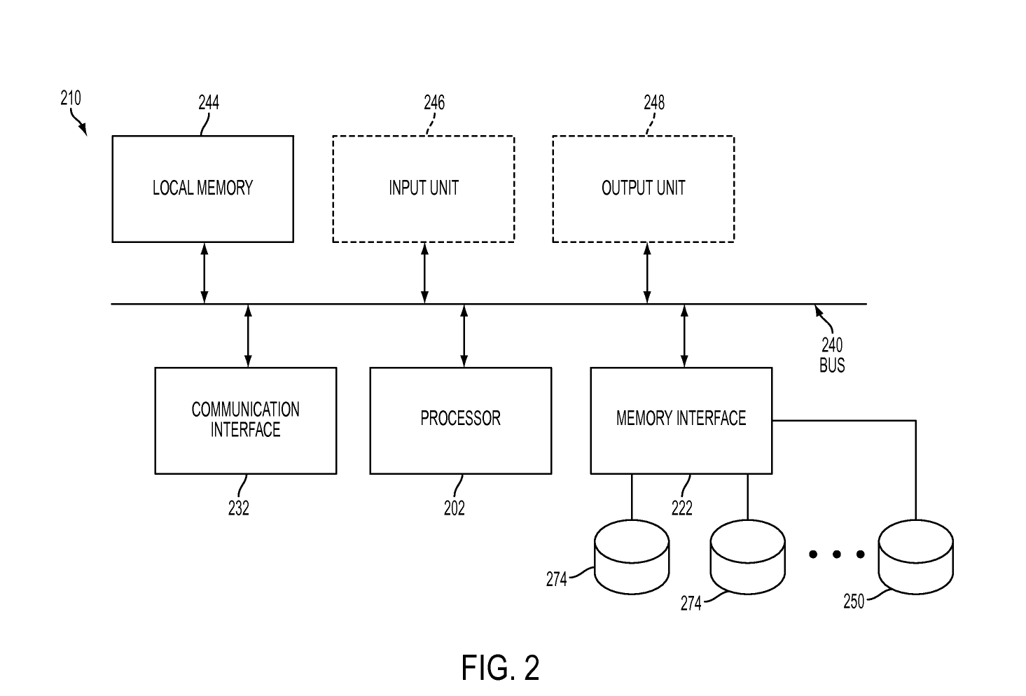

FIG. 2 is an exemplary diagram of a server 210 in an implementation consistent with the principles of the disclosure to achieve the desired technical effect and transformation. Server 210 may include a bus 240, a processor 202, a local memory 244, one or more optional input units 246, one or more optional output units 248, a communication interface 232, and a memory interface 222. Bus 240 may include one or more conductors that permit communication among the components of chunk server 250.

Processor 202 may include any type of conventional processor or microprocessor that interprets and executes instructions. Local memory 244 may include a random access memory (RAM) or another type of dynamic storage device that stores information and instructions for execution by processor 202 and/or a read only memory (ROM) or another type of static storage device that stores static information and instructions for use by processor 202.

Input unit 246 may include one or more conventional mechanisms that permit an operator to input information to a server 110, such as a keyboard 118, a mouse 120 (shown in FIG. 1), a pen, voice recognition and/or biometric mechanisms, etc. Output unit 248 may include one or more conventional mechanisms that output information to the operator, such as a display 134, a printer 130 (shown in FIG. 1), a speaker, etc. Communication interface 232 may include any transceiver-like mechanism that enables chunk server 250 to communicate with other devices and/or systems. For example, communication interface 232 may include mechanisms for communicating with master and clients.

Memory interface 222 may include a memory controller 122. Memory interface 222 may connect to one or more memory devices, such as one or more local disks 274, and control the reading and writing of chunk data to/from local disks 276. Memory interface 222 may access chunk data using a chunk handle and a byte range within that chunk.

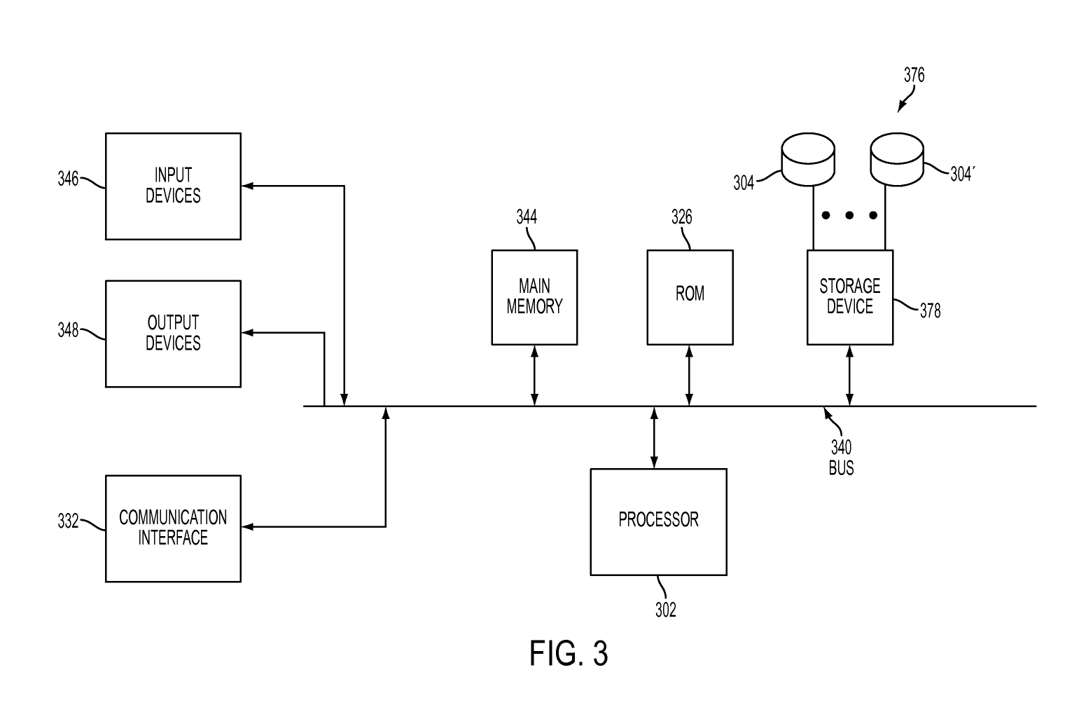

FIG. 3 is an exemplary diagram of a master system 376 suitable for use in an implementation consistent with the principles of the disclosure to achieve the desired technical effect and transformation. Master system 376 may include a bus 340, a processor 302, a main memory 344, a ROM 326, a storage device 378, one or more input devices 346, one or more output devices 348, and a communication interface 332. Bus 340 may include one or more conductors that permit communication among the components of master system 374.

Processor 302 may include any type of conventional processor or microprocessor that interprets and executes instructions. Main memory 344 may include a RAM or another type of dynamic storage device that stores information and instructions for execution by processor 302. ROM 326 may include a conventional ROM device or another type of static storage device that stores static information and instructions for use by processor 302. Storage device 378 may include a magnetic and/or optical recording medium and its corresponding drive. For example, storage device 378 may include one or more local disks that provide persistent storage.

Input devices 346 used to achieve the desired technical effect and transformation may include one or more conventional mechanisms that permit an operator to input information to the master system 374, such as a keyboard 118, a mouse 120, (shown in FIG. 1) a pen, voice recognition and/or biometric mechanisms, etc. Output devices 348 may include one or more conventional mechanisms that output information to the operator, including a display 108, a printer 142 (shown in FIG. 1), a speaker, etc. Communication interface 332 may include any transceiver-like mechanism that enables master system 374 to communicate with other devices and/or systems. For example, communication interface 332 may include mechanisms for communicating with servers and clients as shown above.

Master system 376 used to achieve the desired technical effect and transformation may maintain file system metadata within one or more computer readable mediums, such as main memory 344 and/or storage device.

The computer implemented system provides a storage and delivery base which allows users to exchange services and information openly on the Internet used to achieve the desired technical effect and transformation. A user will be enabled to operate as both a consumer and producer of any and all digital content or information through one or more master system servers.

A user executes a browser to view digital content items and can connect to the front end server via a network, which is typically the Internet, but can also be any network, including but not limited to any combination of a LAN, a MAN, a WAN, a mobile, wired or wireless network, a private network, or a virtual private network. As will be understood a very large numbers (e.g., millions) of users are supported and can be in communication with the website at any time. The user may include a variety of different computing devices. Examples of user devices include, but are not limited to, personal computers, digital assistants, personal digital assistants, cellular phones, mobile phones, smart phones or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application adapted to allow access to web pages on the World Wide Web. The browser can also include a video player (e.g., Flash™ from Adobe Systems, Inc.), or any other player adapted for the video file formats used in the video hosting website. Alternatively, videos can be accessed by a standalone program separate from the browser. A user can access a video from the website by, for example, browsing a catalog of digital content, conducting searches on keywords, reviewing aggregate lists from other users or the system administrator (e.g., collections of videos forming channels), or viewing digital content associated with particular user groups (e.g., communities).

### V. Computer Network Environment

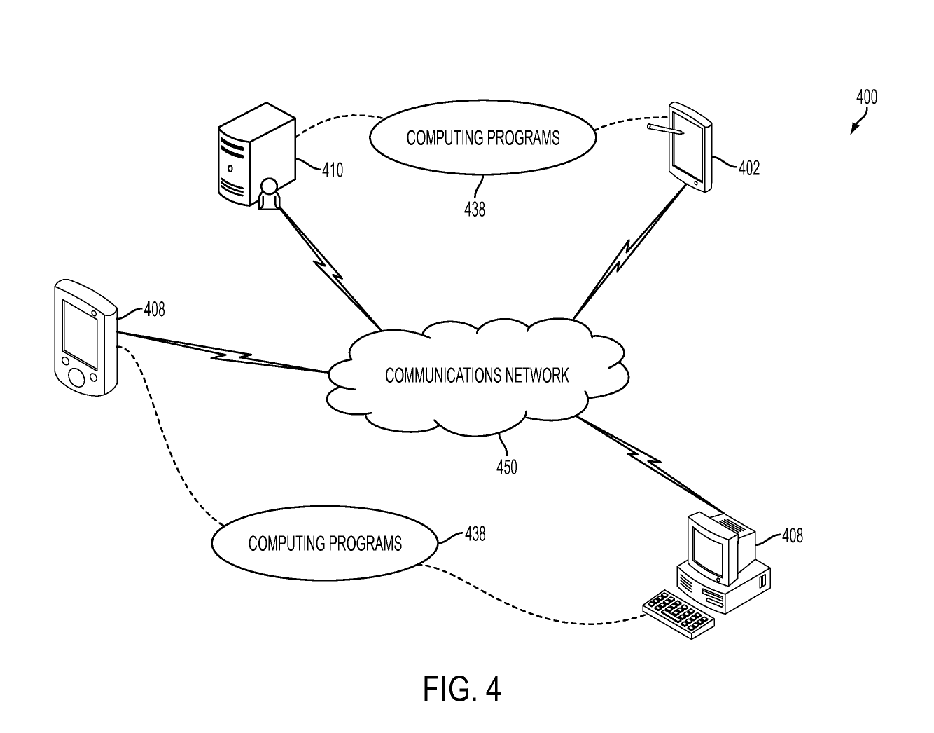

Computing system 100, described above, can be deployed as part of a computer network used to achieve the desired technical effect and transformation. In general, the above description for computing environments applies to both server computers and client computers deployed in a network environment. FIG. 4 illustrates an exemplary illustrative networked computing environment 400, with a server in communication with client computers via a communications network 450. As shown in FIG. 4, server 410 may be interconnected via a communications network 450 (which may be either of, or a combination of a fixed-wire or wireless LAN, WAN, intranet, extranet, peer-to-peer network, virtual private network, the Internet, or other communications network) with a number of client computing environments such as tablet personal computer 402, mobile telephone, smart phone 408, and personal digital assistant 402. In a network environment in which the communications network 450 is the Internet, for example, server 410 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the disclosure, including, for example Wireless Markup Language (WML), DoCoMo i-mode (used, for example, in Japan) and XHTML Basic. Additionally, networked computing environment 400 can utilize various data security protocols such as secured socket layer (SSL) or pretty good privacy (PGP). Each client computing environment can be equipped with operating system 438 operable to support one or more computing applications, such as a web browser (not shown), or other graphical user interface (not shown), or a mobile desktop environment (not shown) to gain access to server computing environment 400.

In operation, a user (not shown) may interact with a computing application running on a client computing environment to obtain desired data and/or computing applications. The data and/or computing applications may be stored on server computing environment 400 and communicated to cooperating users through client computing environments over exemplary communications network 450. The computing applications, described in more detail below, are used to achieve the desired technical effect and transformation set forth. A participating user may request access to specific data and applications housed in whole or in part on server computing environment 400. These data may be communicated between client computing environments and server computing environments for processing and storage. Server computing environment 400 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### VI. Media Independent Information Service

The Media Independent Information Service (MIIS) provides a framework and corresponding mechanisms by which an MIHF entity may discover and obtain network information existing within a geographical area to facilitate handovers. Additionally or alternatively, neighboring network information discovered and obtained by this framework and mechanisms can also be used in conjunction with user and network operator policies for optimum initial network selection and access (attachment), or network re-selection in idle mode.

MIIS primarily provides a set of information elements (IEs), the information structure and its representation, and a query/response type of mechanism for information transfer. The information can be present in some information server from which, e.g., an MIHF in the Mobile Node (MN) can access it.

Depending on the type of mobility, support for different types of information elements may be necessary for performing handovers. MIIS provides the capability for obtaining information about lower layers such as neighbor maps and other link layer parameters, as well as information about available higher layer services such as Internet connectivity.

MIIS provides a generic mechanism to allow a service provider and a mobile user to exchange information on different handover candidate access networks. The handover candidate information can include different access technologies such as IEEE 802 networks, 3GPP networks and 3GPP2 networks. The MIIS also allows this collective information to be accessed from any single network. For example, by using an IEEE 802.11 access network, it can be possible to get information not only about all other IEEE 802 based networks in a particular region but also about 3GPP and 3GPP2 networks. Similarly, using, e.g., a 3GPP2 interface, it can be possible to get access to information about all IEEE 802 and 3GPP networks in a given region. This capability allows the MN to use its currently active access network and inquire about other available access networks in a geographical region. Thus, a MN is freed from the burden of powering up each of its individual radios and establishing network connectivity for the purpose of retrieving heterogeneous network information. MIIS enables this functionality across all available access networks by providing a uniform way to retrieve heterogeneous network information in any geographical area.

### VII. Software Programs Implementable in the Computing and Network Environments to Achieve a Desired Technical Effect or Transformation

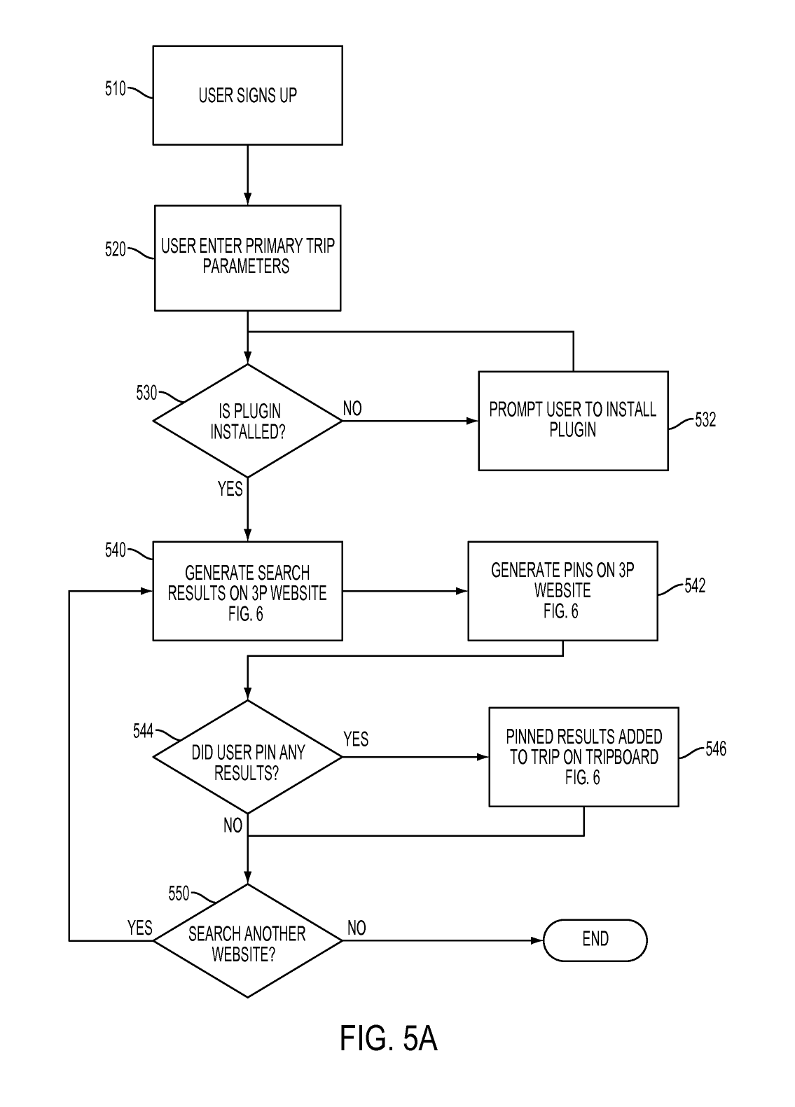

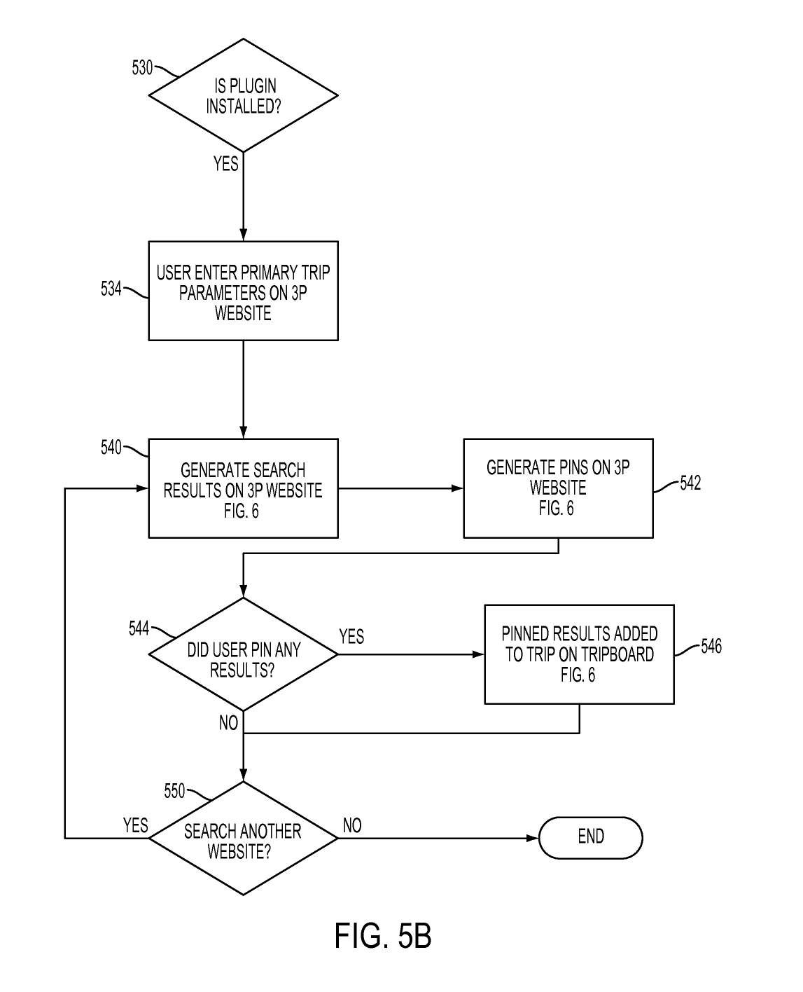

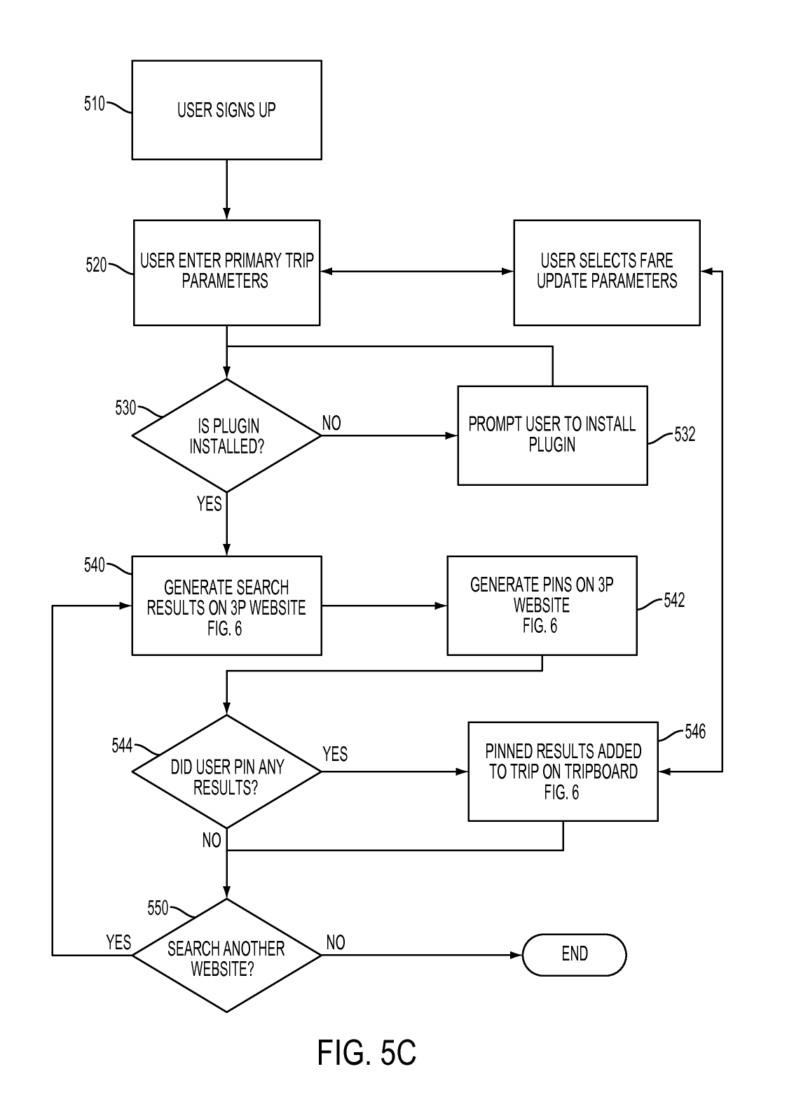

FIG. 5A illustrates a process of pinning travel products for a trip. Trips include, for example, parameters specified by a user which can include, but are not limited to travel dates, destination and travel options. In one configuration, after launching the travel planning website, a user is prompted to sign-in (e.g., using an email and password combination) or sign-up 510. Other mechanism to provide secure access can be used including, for example, the use of biometric information obtained from the user using a biometric device associated with the computing device. Travel products can be pinned, marked or manually added. A variety of processes can be used to capture travel products including, but not limited to, pinning a travel product, pinning an image, sending an image of the desired travel products search result to the system, sending the html of the desired travel products search results to the system, manually pinning, etc. Information can be extracted into an entry within the tripboard.

Once signed in or once the plugin or extension in is installed or start using the platform, the user enters primary trip parameters 520, such as dates, type of the travel product, starting location (e.g., city or airport code), ending location (e.g., city or airport code). Additional parameters can be included, or provided as part of a user profile (e.g., price preferences, seating location, time of day for travel, preferred airports, preferred transportation mechanisms, meal preferences, level of the travel product (hotel), medical conditions, or any other information that would be relevant to a travel products provider). At this point, in one configuration, the system is configurable to determine whether a plugin or extension is installed 530.

The plugin or extension functions to enable the marked travel products to be placed into a central location on a password protected platform or website. The central location includes buckets or file folders are collected in one place, such as on a single webpage, where the user collects travel products from other websites for review and comparison in one location. This bucket is configurable to provide a general overview of the user's account and all the accounts content. The bucket, or tripboard, is generated on one web page from information marked on one or more other webpages, and is an electronic location where the user can collect travel information. The information on the tripboard includes any travel related items such as but not limited to airline flights with pricing, people who are included in the travel or in the plans, conversations between all the parties involved in the travel plans. As will be appreciated by those skilled in the art, the methods and operations envisioned by the system can be achieved without the use of a plugin or extension.

The platform enables users to have access to multiple trips/tripboards from one location called a dashboard. A user can either have created one or more trips, have been invited to one or more trips or a combination of both. The dashboard is configurable to reflect all current and past trips that the specific user has been involved in as a trip creator or as an invitee. This can also be used for users who are not part of the travel group, but a user who is helping plan and coordinate the trip. When a user is accessing a dashboard the user just needs to select the trip that they are interested in exploring more to see the tripboard for that trip.

In one aspect of the system, if the plugin or extension is not installed, then the user is prompted to install the plugin 532. If the plugin or extension has previously been installed, then search results are generated on a selected third party website 540 selected by the user Selected third party websites are, for example, travel websites that provides consumers with travel products (airfare, transit, hotel, etc.) for sale whether the websites sell the information or act as an intermediary for the sale of travel products. When the user views the search results having specific travel items on the third party website results page, in one aspect visual markers, such as pins, are generated on the website 542, which allow the user to mark a specific travel item of interest. A specific travel item or travel products is the description for any of the following but not limited to air itinerary, hotel reservation, car rental and any other item sold on any travel website. Other mechanisms can be employed to provide for visual markers on the third party websites that are capable of engaging with the dashboard including, for example, by providing software on the third party website.

The pin or button is injected in the different travel sites next to each travel option a user could select. By pressing the button, the user bookmarks that specific travel item to their tripboard. The button can either be injected through the installation of an extension in the user's browser or through injecting the code directly into the travel sites. As will be appreciated by those skilled in the art, the results page for a travel site is the page where travel products offered by the third party travel websites or platforms can be found.

The pinning or marking process bookmarks a specific travel related search result from a third party travel site other than the primary website with the tripboard onto the tripboard. As will be appreciated by those skilled in the art, there are multiple ways that bookmarking a travel product to the tripboard. A variety of ways to pin/bookmark travel products are contemplated. Such mechanisms include but are not limited to:
1. Through clicking a visual marker or pin
2. By clicking and holding the travel item on the travel site
3. Through a screenshot of the travel item, either as a full-screen or of a selected area
4. By entering the information manually on the primary website. The information needed in order to recreate the complete travel product on the tripboard can be specified by the primary website platform.
5. Sending the travel product description via electronic means such as, but not limited to email. The description should have all the needed information in order to recreate the travel product on the tripboard
6. By dragging the item to a bucket.
   As will be appreciated by those skilled in the art, other mechanism can be developed to achieve the same functionality without departing from the scope of the disclosure.

The pinning or marking process that uses a click of a button can be achieved in one step or multiple steps. The pinning through a button can be achieved, for example, by, but is not limited to the following:
1. Certain travel sites provide a complete product that can be bookmarked with one click
2. Certain travel sites provide a two-step process to enable the bookmarking of a complete travel product on the same page
3. Certain travel sites provide a two-step process to enable the bookmarking of a complete travel product on two separate pages. Once the first part of the product has been bookmarked the user will move on to a next page where the user will be able to bookmark the remainder in order to create a complete travel product.
4. Certain travel sites require a multi-step process in order to create a complete bookmarked travel product.

Most travel sites require users to enter travel parameters prior to arriving to a results page. If travel products are pinned 544, then the pinned results are added to a trip on the tripboard 546. The user can continue to review the third party website and pin or mark additional travel products of interest. Thereafter, from the third party website the user can select another website to search 550 using the same parameters, without reentering the parameters. At this point new search results are generated on a third party website 540, which is a third party different than the first third party website searched. The pinning or marking action results in a bookmark of a specific travel item from a travel site being placed onto a tripboard. The pinning or marking process results in an extraction of necessary information based on the user's request to recreate the exact same travel product on their tripboard as well as the information needed in order to provide the user with a price update.

Typically users will interact with the system in a session, such as a search session. Search sessions include searches performed on travel sites within a single sitting. The system is configurable such that if a user does not have interaction with any travel site for a period of time (e.g., 5 minutes, 10 minutes, etc.), the current instant of the search session is terminated. As will be appreciated by those skilled in the art, the amount of time can vary without departing from the scope of the disclosure. Moreover, in some configurations, the user can set a time for expiration of a session in the user's profile and settings which is tailored to the user's own behavior.

As shown in FIG. 5B, when the plugin or extension is installed 530, the user can enter primary trip parameters directly on a third party website 534 as a starting point. When the user views the search results on the third party website visual markers, such as pins, are generated on the website 542, which allow the user to mark a travel product of interest. If travel products are pinned 544, then the pinned results are added to a trip on the dashboard 546. If no travel products are pinned, the user can select another website to search 550 using the same parameters, without reentering the parameters. At this point new search results are generated on a third party website 540, which is a third party different than the first third party website searched. In one configuration, once the plugin or extension is installed, the user can start the searching process directly on a third party travel related website. Once the primary trip parameters are entered, the user will see a variety of travel products to choose from. Because the plugin or extension is installed on the computing device. visual markers (e.g., pins) will also be visible and associated with each travel products of the search result. The user can then select as many, or none, of the travel products in the search. From this point, the user can then proceed directly to another third party travel related website. The user can select another third party travel site. From this point, the application transitions the user to a results page on the specified third party site for the specific trip without the need to add the search parameters. At each point in the process, whenever the user marks or pins a travel product of interest, the travel products details are transferred to the dashboard without the need for the user to navigate between webpages. Additionally, if, upon analysis by the system. a travel product seems to belong to an existing trip (e.g., by virtue of one or more primary parameters), then the pinned or marked result will be added to the existing trip on the tripboard. If the travel product does not belong to an existing trip on the trip board, then a new tripboard with new trip parameters will be automatically grated and the newly identified travel product of interest will be added to that newly created tripboard. In another configuration, a pop-up identifying an existing trip based on the analysis will be provided at which point the user can confirm the association of the newly marked travel product to the existing trip or have the travel product associated with a new category.

Turning now to FIG. 5C, as discussed above, after launching the website, a user is prompted to sign-in (using an email and password combination) or sign-up 510. Once signed in, the user enters primary trip parameters 520, such as dates, starting location (e.g., city or airport code), ending location (e.g., city or airport code). Additional parameters can be included, or provided as part of a user profile, as described above. Additionally, the user can select, for example fare update parameters 522 in order to set a frequency at which the user would like to receive an update on the fares for selected trips of interest. As described above, the system then determines whether a plugin or extension is installed 530. If the plugin or extension is not installed, then the user is prompted to install the plugin 532. If the plugin or extension has previously been installed, then search results are generated on a selected third party website 540. When the user views the search results on the third party website visual markers, such as pins, are generated on the website 542, which allow the user to mark a travel products of interest. If travel products are pinned 544, then the pinned results are added to a trip on the dashboard 546. If no travel products are pinned, the user can select another website to search 550 using the same parameters, without reentering the parameters. At this point new search results are generated on a third party website 540, which is a third party different than the first third party website searched.

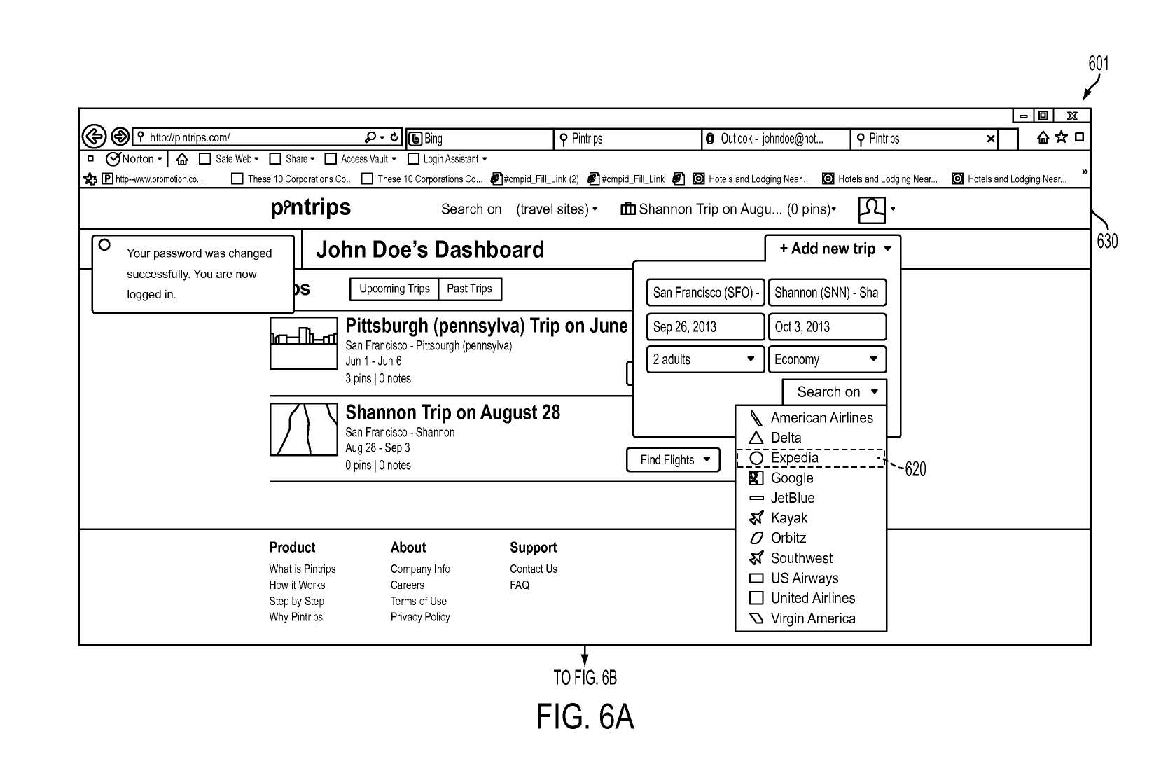

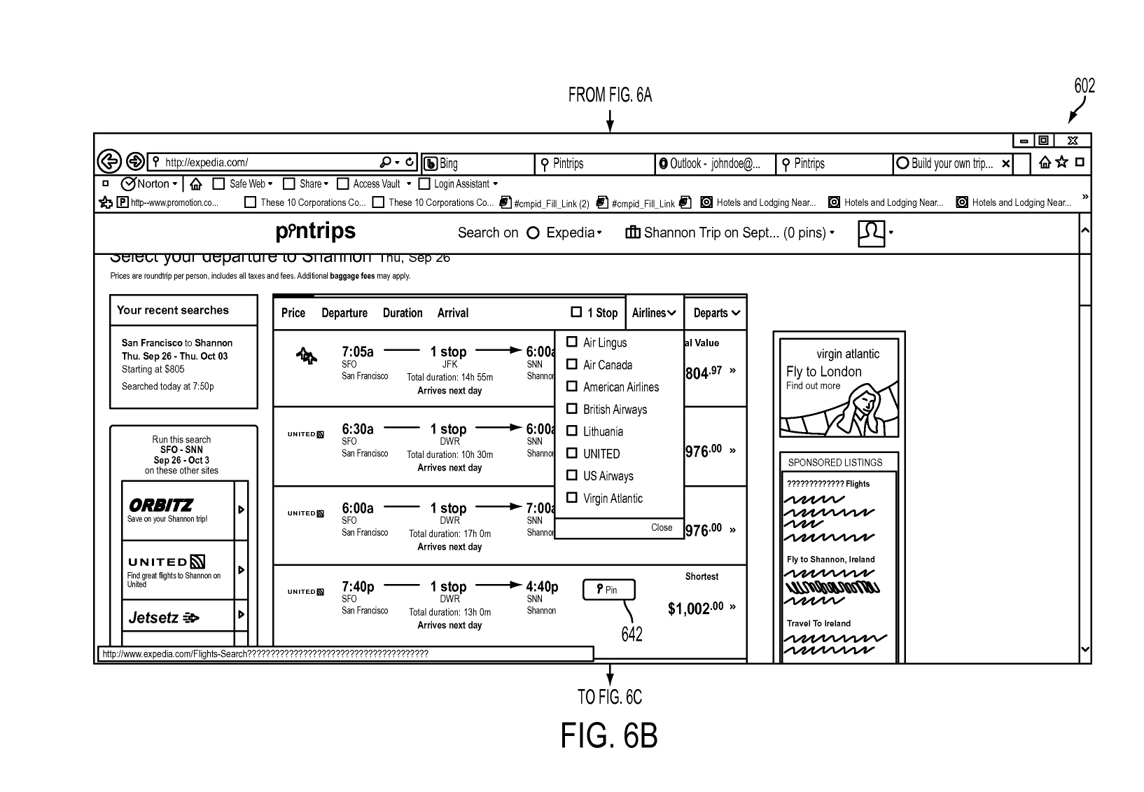

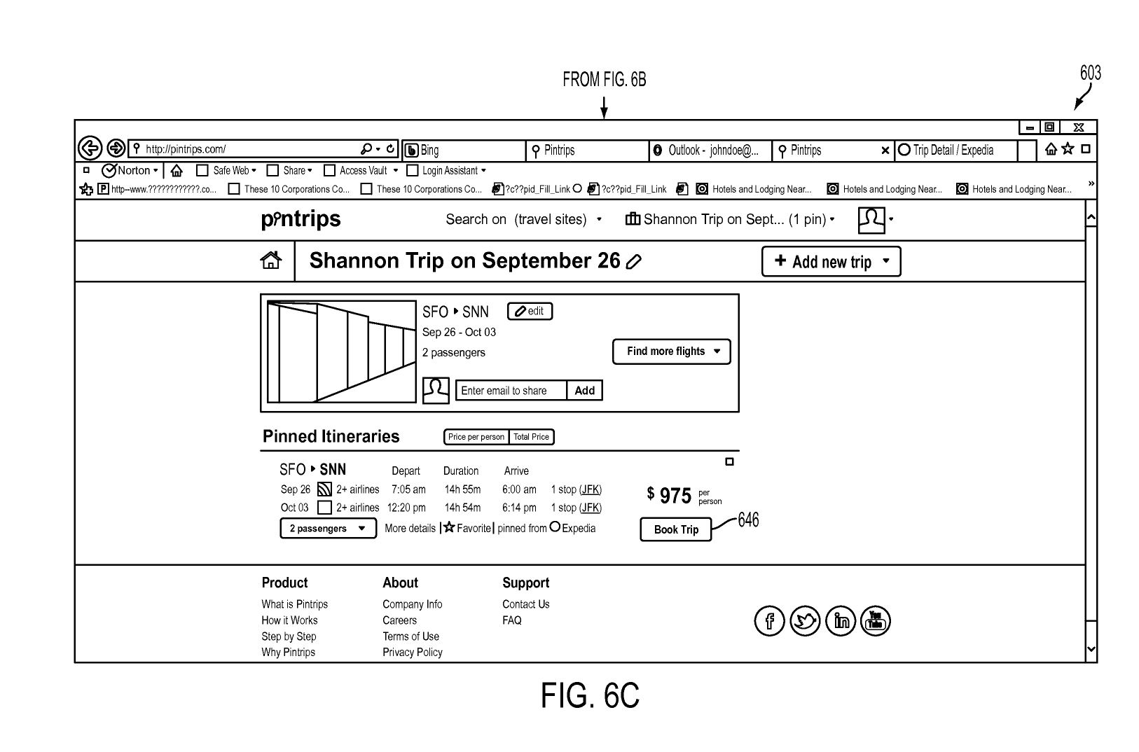

Turning now to FIG. 6A-c, from a first website page 601 where the dashboard 630 is visible, a user searches on a first website 620, such as a selected (or entered) travel website Expedia®. A new screen is loaded 602 (e.g., in a new tab) which includes travel products that meet the criteria of the primary search parameters entered. Markers 642 or pins appear embedded in the third party website which the user can select to indicate a trip that the user wants to consider. The pinned or electronically marked one or more travel products of interest then appear in a trip folder 603 on the dashboard. From the dashboard, all the marked or pinned trips can be reviewed and a final purchase decision can be made. If the user elects to book a trip, then the user will be taken back to the website from which the travel products was generated. Alternatively, the system is configurable so that the user will be given the option to proceed to the selected pinned website or to another website that may or may not be one of the pinned or marked travel products on the dashboard to arrange for purchase. Thus, for example, if a user were to pin 2 trips on American Airlines, 1 trip on Expedia®, and four trips on Kayak®, upon selecting, for example, the Expedia® trip for purchase, the user would then be returned to Expedia or the operator site, or any other website that might carry that travel product and the selected trip details would be populated in in preparation for the purchasing process.

Thus, as apparent from the screenshots, the system helps a user navigate to and search on multiple travel sites easily without having to re-enter any travel parameters and navigate from results page to the next results page seamlessly. The user can choose the website they want to visit with no limitation to the one they want to visit. While navigating to different sites, the system is able to identify if the user is already on the tripboard, and message the user that they have been bookmarked. As will be appreciated, there are several ways to navigate from site to site based on the trip created. For example, a new trip has been created and the user wants to visit an initial site.

After the user creates an initial trip on the tripboard the will have the option to navigate from to an initial third party website without having to re-enter the travel parameters, just by selecting the travel site of choice from a list provided as shown in FIG. 6B or enter a site name. The user can then be automatically redirected to a search results page as shown in FIG. 6B. From that travel site the user can select from the dropdown provided by the primary website or toolbar to navigate to another travel site from the list. Once the user selected the site of their choice, primary website can then automatically redirect them to the results page on that next site. This process can be repeated as often as the user wants, there is no order in which the user has to choose their sites, and the user can revisit the same site multiple times within a search session.

Navigating to travel site from an existing trip. Once a trip has been created the user can navigate back at any time to the dashboard to continue their search. The user would not need to re-create a trip since the parameters have been saved on their tripboard. On the tripboard the user will have the option to navigate from the primary website with the tripboard to a website without having to re-enter the travel parameters, just by selecting a third party travel site of choice from a list provided. On that site the user can again be automatically redirected to the results page. From that travel site the user can select from the dropdown provided by the primary website or toolbar to navigate to another travel site from the list. Once the user selected the site of their choice, the primary website can automatically redirect them to the results page on that next site. This process can be repeated as often as the user wants, there is no order in which the user has to choose their sites, and the user can revisit the same site multiple times within a search session. While the session for the existing trip can be started on the tripboard on the primary website, it can also be started on any travel site. The user can re-initiate a search from within the site without having to enter any travel parameters.

Navigate to travel sites from a trip with different travel parameters. For a trip that has multiple/flexible parameters, a user can navigate to any site for any of the created parameters. On their tripboard the user can see the list of travel parameters that they created, when selecting the parameters they will be able to choose the travel site that they want to visit. Then the process will be the same as in point one in this section.

Navigate to other site while changing travel parameters. For a user that has multiple trips on their dashboard, they can easily navigate to the same site or another site for different travel parameters. While in a travel site they can change the active trip. Once the user selected the site of their choice, primary website can automatically redirect them to the results page on that next site. Then the process will be the same as in point one in this section.

As will be appreciated by those skilled in the art, the process of opening a third party website result page from within the system begins with a user on a first webpage. Once the user selects a third party website from a list of available websites, the webpage then transitions the user to a results page on the specific website for the specific trip (e.g., search results which comply with the primary search parameters entered).

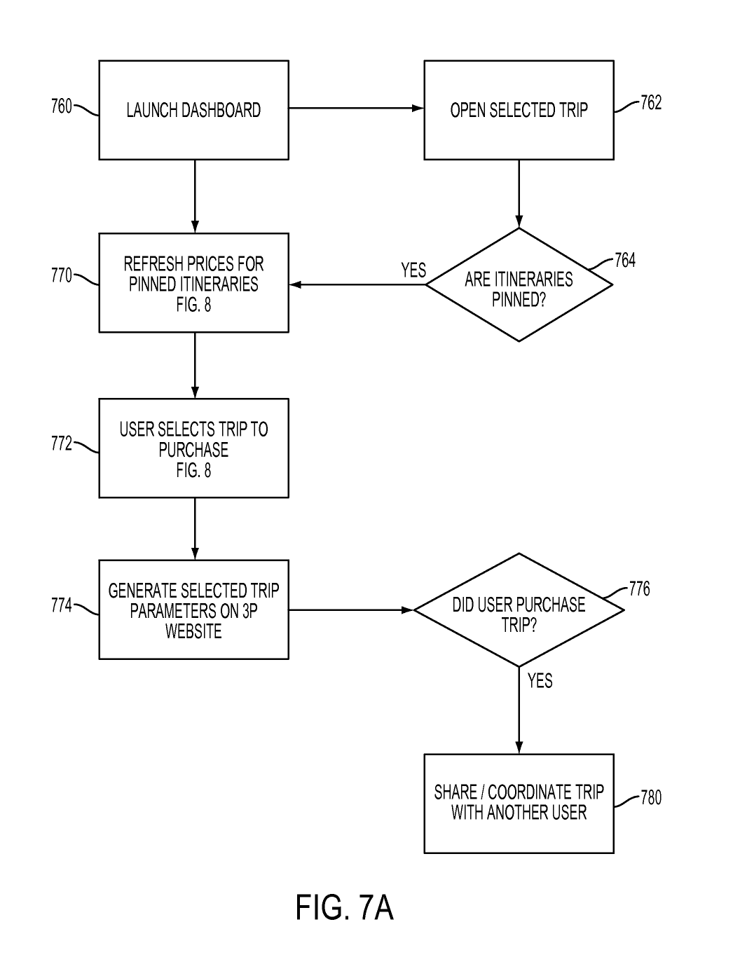

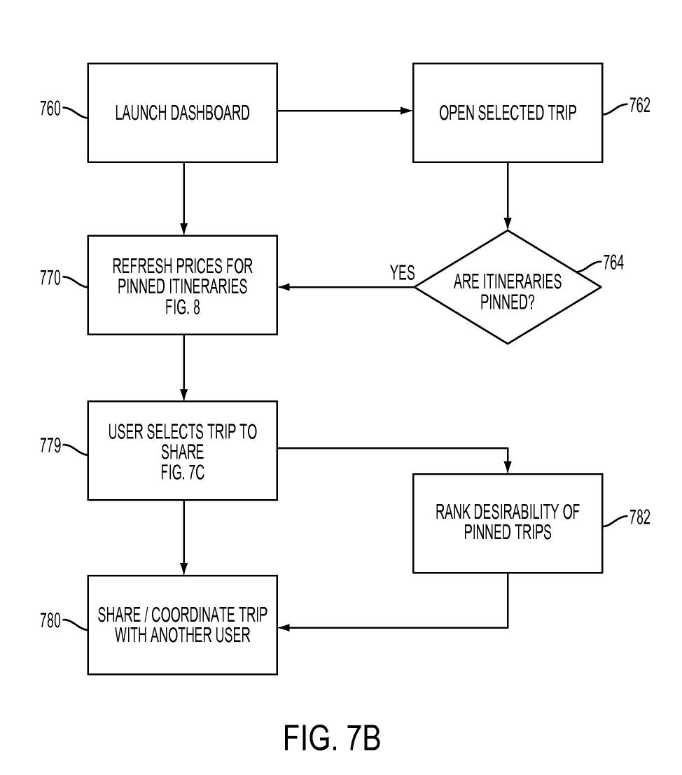

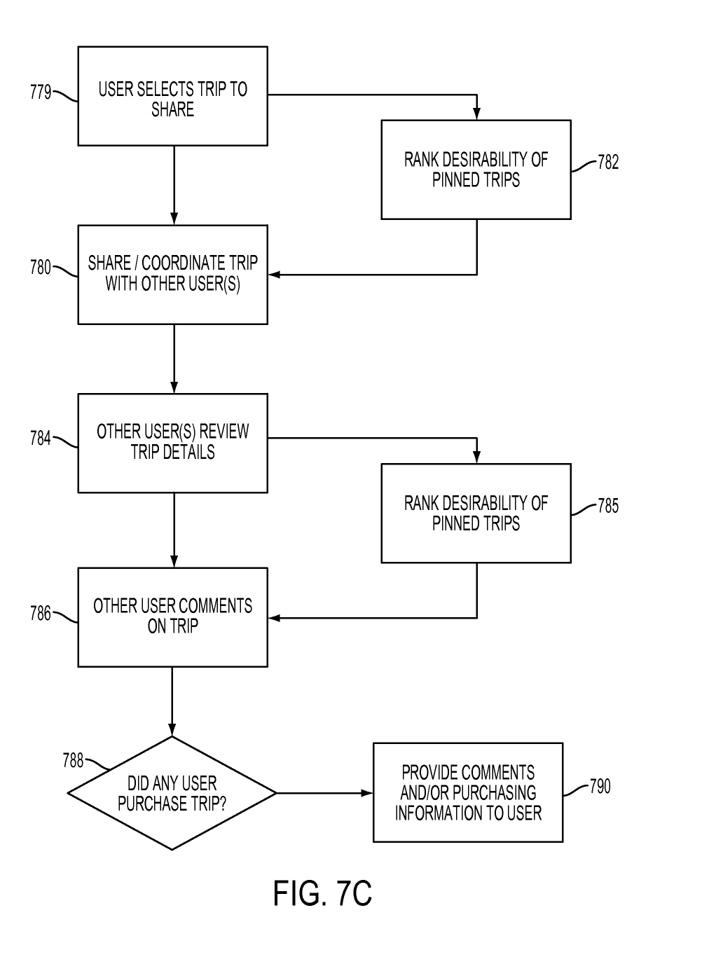

As shown in FIGS. 7A-C, once the dashboard is launched 760, the user can open a selected trip 762. If travel products are pinned 764, then the prices for the pinned or marked travel products are refreshed 770. Additionally, at any time, the user can access the third party websites for travel products and pin additional items (as described above in FIG. 5). From the refreshed prices and associated travel products, the user can select a trip to purchase 772. If the user selects a trip to purchase, that selected trip is then generated with parameters on the third party website (e.g., user selects a trip originally pinned from Expedia®) 774. The system next determines if the user purchased the trip 776. User purchase transaction results in information being passed to the dashboard management system to ensure payment by recipient website. Once a trip is purchased, it can be shared with another user, or trip details can be coordinated with another user 780. As will be appreciated by those skilled in the art, the sharing or coordination of trip details can occur at different times and locations in the process without departing from the scope of the disclosure. For example, as shown in FIG. 7B, after refreshing prices for the pinned travel products 770, the user can then select a trip to share 779, and invite other users to the tripboard for a specific trip at which point the trip is shared and/or coordinated with another user 780. During the sharing process, the user and his or her invitees can, for example, pin more travel products, comments on travel products, rank desirability of pinned trips 782, and share the information back and forth as many times as desired before making a purchasing decision. In an additional exemplar configuration, as shown in FIG. 7C, after sharing and/or coordinating the trip with other users 780, the other users can review trip details 784, rank desirability of pinned trips 785 and/or provide other user comments on the trip and/or any travel products in the trip 786. In at least some configurations, other users can pin additional travel products to add to the trip dashboard, if desired. Additionally, if any of the users purchase the trip from the dashboard 788, the comments and/or purchasing information can be provided to the user 790, for example, “John Smith has purchased the Jun. 1, 2013, American Airlines flight to Pittsburgh.”

The platform enables a user to perform a flexible comparison of travel products related to a single category of travel products on one page. Additionally, where the travel products in a trip folder relate to different aspects, e.g., airfare, hotel, rental car, additional sub-folders can be provided to further organize the trip by those aspects. Alternatively, users can filter or sort the results to list and compare one category of travel product at a time. As will be appreciated by those skilled in the art, the comparison may, but need not, be made of travel products having all of the same parameters (e.g., dates, locations, etc.). Since there are no limitations to the creation of a trip, there are no limitation to what can be bookmarked to the tripboard and/or compared within a folder or category. When a user comes across a travel product of interest, the user can bookmark the website into their tripboard, no matter what site they are on, the destination and the travel dates. This means that a user can compare two or more items that they normally would need to have at least two tabs in their browser open in one location. This enables the user to compare any two or more options they are considering on a single page. There are several options they can compare which include but are not limited to:
1. Same destination, same date range, but from different travel sites
2. Same travel site, but options are so different that they would not show up on the same page even after applying every possible filter.
3. Different destination, same date range, same site
4. Different destination, same date range, different site
5. Same destination, different date range, same site
6 . . . . And so on.

The platform is also configurable to enable a user to choose with whom they wish to share a particular trip with. In the dashboard the user might have more than one active trip. For each trip the user has a created tripboard, that tripboard can be shared with a select group of people, who can view, comment and participate in building the tripboard. Only the people who have been invited to the tripboard have access to that specific tripboard. Users can be invited through several medium including but not limited to email, social networks and others. The invitation remains at the tripboard level and not at the dashboard level. This means that in one dashboard, a user can have multiple trips where each trip has been share with another select group of people. In some configurations, a user can provide access to the entire dashboard (e.g., to an administrative assistant helping with all travel arrangements).

The platform is also configurable to offer the ability to chat between the users involved in the specific trip. A chat area is created for each tripboard and is visible to all users involved in that trip. Further the user can also leave personal notes behind in order to remember something specific related to the travel items on the tripboard.

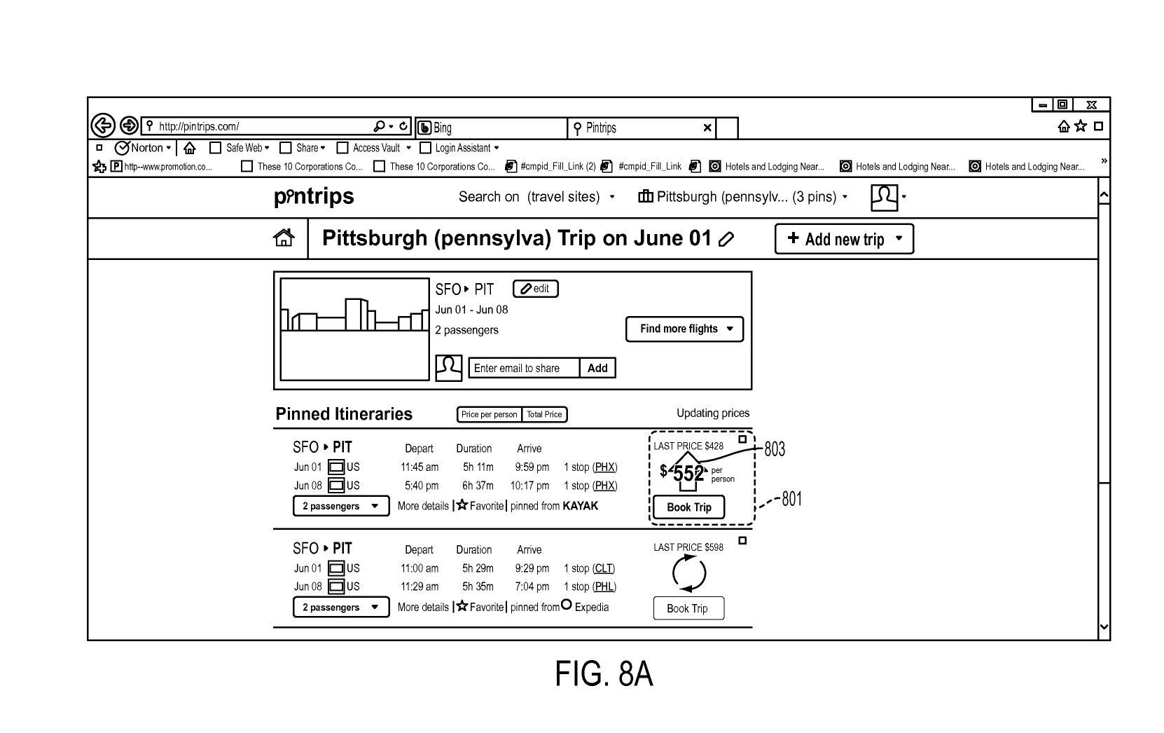

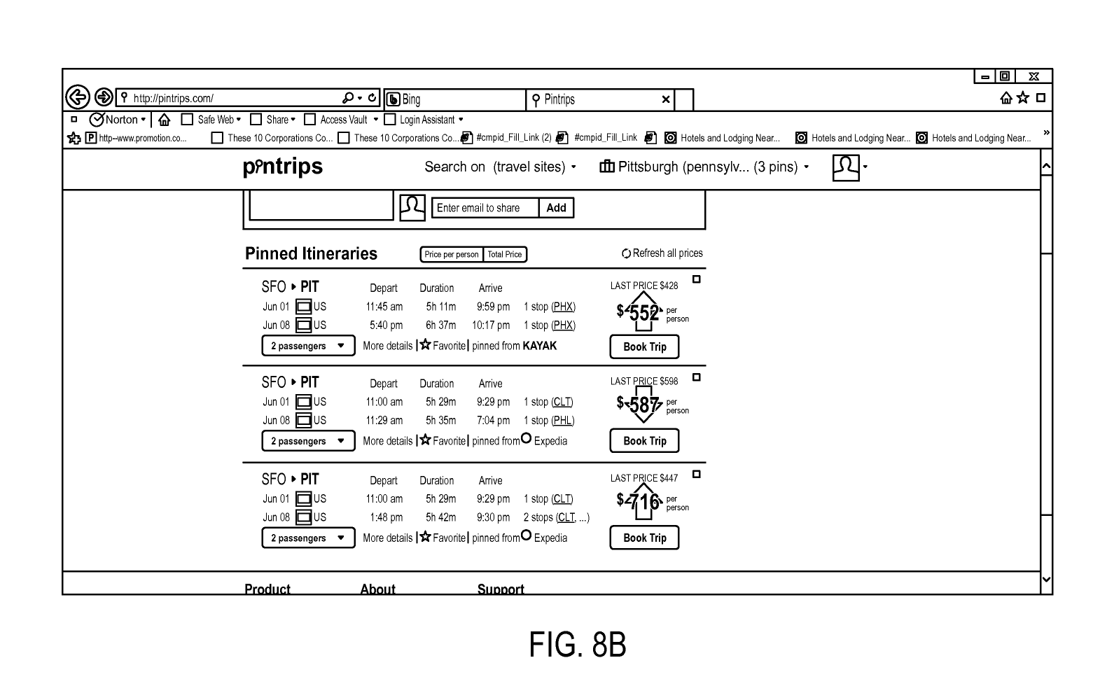

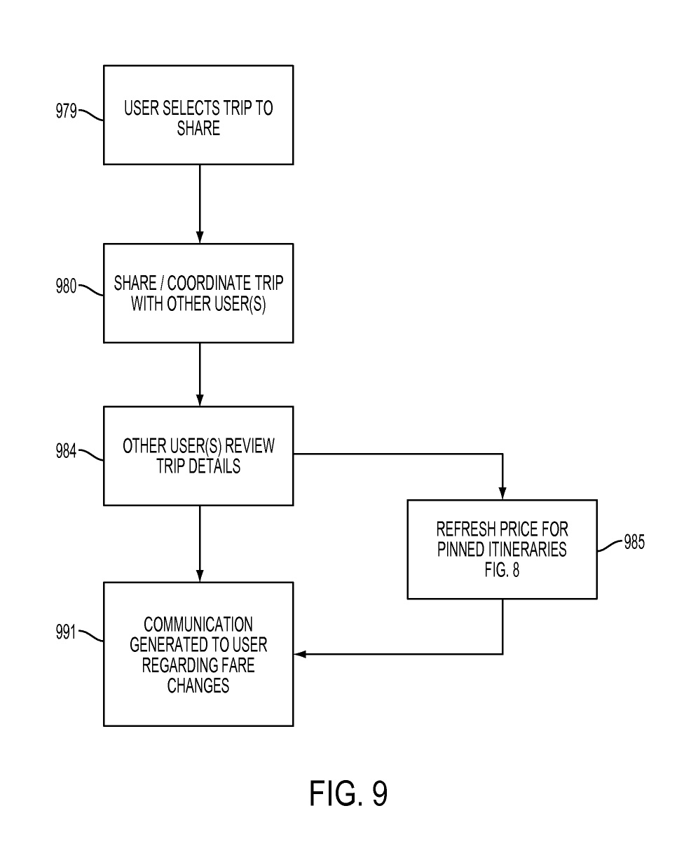

FIGS. 8a-b illustrates screen shots of updating a price from within the system. Once the user enters the dashboard, all the pinned travel products communicate with the source platform and provide a refreshed price 801 and/or availability for the pinned travel products. Additionally, an indication of whether the price is increasing or decreasing 803 can also be provided. All pinned travel products in the trip board are automatically or semi-automatically updatable by refreshing the trip data with the one or more third party websites. Each individual links to purchase a specific travel products within selected travel products is updatable as well. The system is configurable such that it can display the originating travel site of a travel product on the tripboard. Even if at the time of purchase the platform is configurable such that it can refer the user to another travel site, the originating travel site can still be displayed.

The platform can also enable the user to book/purchase the travel product from the travel site of their choice, regardless of where the initial bookmarking of the travel product was made. The platform provides as many options as possible that sell that travel product even if the price may be different. The user will then choose the travel site they are interested in purchasing the product from, and the primary website platform can automatically send the user to the page on their selected travel site where that can purchase the product in question.

The platform is configurable to update prices for each travel product that has been bookmarked to a tripboard. When a user bookmarks a travel product to a tripboard, each time they revisit the board, the primary website system can then automatically update the price for the items in the board. The user also has the ability to manually update the price for the items in the board. Further, the platform can show price history for each item in the board for every time the user logged into their account and visited the specific tripboard, this means that the user has access to the price variation through time of specific travel offerings. While a specific item could belong to more than one tripboard and to more than one user, each time that a travel product gets a price update, the system tracks what other board has that specific product and update it automatically as well. In that instance the system has the ability of notifying the user through any communications medium that an update on their board has occurred. Further, the user will have the ability to specify when they would like to be notified if a price update occurred for what specific item and at what price prior to being notified.

The system is also configurable to use smart bookmarking to determine the location i.e. which tripboard best applies to the specific travel item. Thus, for example, when a user bookmarks a travel product the system is configurable to determine whether to add the marked travel item to an existing tripboard (e.g., folder or category) or whether to create a new tripboard based on the parameters of the travel item. The platform will use an algorithm that has been developed for the sole purpose of fulfilling this requirement. For example, if the dashboard has a tripboard directed to Disneyland in August 2013, and a subsequent search is performed for a trip to Anaheim in August 2013, the system can be configured to recognize that relationship and place the travel products into the tripboard for Disneyland. Alternatively, the system can make an initial determination and then request confirmation from the user. Thus for example, if the dashboard has a tripboard directed to Disneyland in August 2013, and a subsequent search is performed for a trip to Anaheim in August 2013, the system can be configured to recognize that relationship at which point, a pop-up can be provided “Place in the Disneyland August 2013 tripboard?” The user could then confirm whether the searched item should be placed in the tripboard.

FIG. 9 illustrates a process of inviting users to view a specific trip. In this process a user manages travelers and guests under one specific trip. The user can then invite, e.g. through a social network, email, or other process, a second user to share or view the data. Each person invited will then be able to interact with the specific trip information. The platform also enables users to coordinate meeting at a specific location from 2 or more origins. The ability of bookmarking travel options for the same destination, but originating elsewhere gives the ability to users to coordinating meeting in one location by comparing the options from both origins side by side.

As shown in FIG. 9, the user can select a trip to share 979 and then invite one or more other users to share and/or coordinate the trip with other user(s) 980. As will be appreciated by those skilled in the art, the user can select and then share, or have an active trip that is shared later in the process. Sharing can occur at any point. Once the trip is shared, other user(s) can add more pinned travel products, add comments, review trip details 984, refreshing of price details can occur when the user accesses the travel products or when anyone (user or other invited user(s)) access the travel products 985. When the refreshing of price details occurs, e.g., when the user or any user accesses the travel products, a communication an be generated to everyone or a select number of people having access to the travel products of the change in prices 991 and/or availability. Purchasing by any user at any time can also occur.

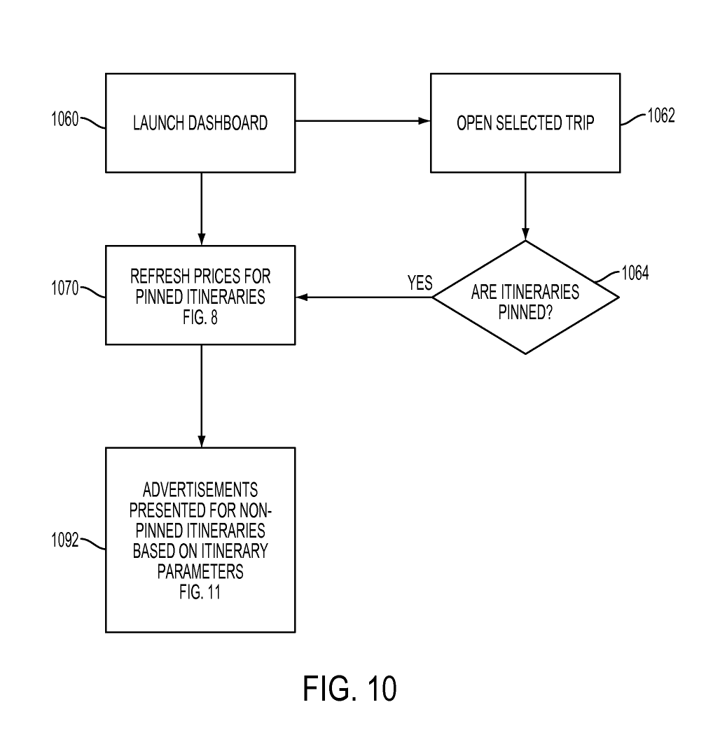

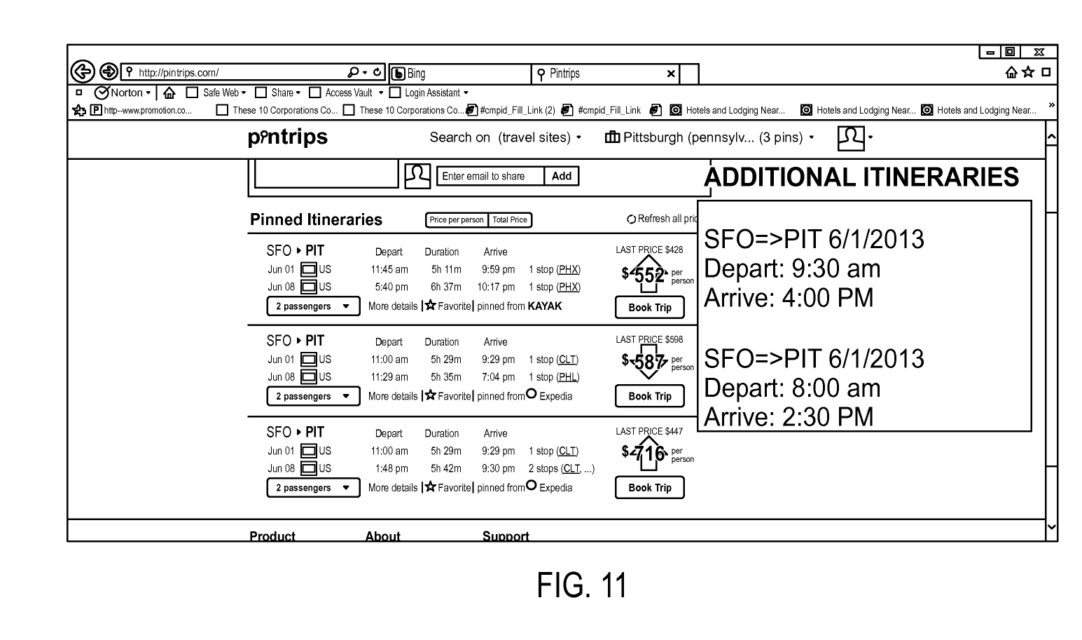

Turning now to FIG. 10, a process for providing relevant advertisements is contemplated. For example, after the user or an invited participant, launches the dashboard 1060, the user can open a selected trip 1062. If travel products are pinned 1064, then prices for the pinned travel products can be pinned 1070. As will be appreciated by those skilled in the art, the pinned travel products can either be on the main page or located within a trip folder which is manually or automatically created. In conjunction with refreshing the prices for the pinned travel products, relevant advertisements might be placed which show additional travel options that reflected in the already pinned travel products. FIG. 11 illustrates an exemplar screen shot with an advertising bar to the right side.

The platform also enables advertisers to target their offering to specific users who might be interested in specific items. The platform has information on content from the tripboard. The content includes and is not limited to people travelling or planning, reason of trip, duration, interest communication, etc. Through this content the platform will offer targeted advertising to its partners. This means that only offers who have specific value to the users of that tripboard will be publicized on that board. There is no generic advertising that will be displayed on all boards simultaneously.

The platform will also enable the promotion of private fares. Since all boards are limited in view by the people who are part of the board and every account is password protected. The platform enables for publishing of private fares. This means that only the boards where the content of the private fare matches or is similar to the content of the specific board, the private fare will be available to be viewed by that board only.

### VII. EXAMPLES

Trip Creation.

Trips can be created actively by entering parameters through a new trip creation process, or can be created passively by performing a new search on any travel site if the dashboard has been installed on the user's computer. Through the creation of a trip the user will create a tripboard. Each trip created will be for at least one destination and one date range, but it is not bounded to either one destination or one specific pair of dates. The user can create a trip with any number of combinations, and bookmark items from other travel sites to that dashboard for all combinations defined for that trip, but the user is not limited to bookmark for those parameters. Types of trips that can be created:

1. Trip with only one parameter: Fixed destination and fixed date range

2. Trip with multiple parameters:
a. Fixed destination and multiple/flexible date ranges
b. Multiple/Flexible destinations and fixed date range
c. Multiple/Flexible destinations and multiple/flexible date range
d. Multiple/Mixed travel item providers

The system is configurable such that a user can pin or mark non-matching items. For example, an outbound segment from one site (e.g., Kayak®) and a return segment from a completely different site (e.g., Virgin America®), thus facilitating for example, open-jaw air travel or using different carriers for each leg of a trip to a destination. In either scenario, the system then combines them into 1 round-trip itinerary. This facilitates the user finding and choosing and matching segments optimally based on their own needs.

Additionally, a category or trip can be created that includes pinned or marked items that have one or more common primary parameters or one or more overlapping primary parameters. Thus, for example, a category or trip can be created for potential trips over the Thanksgiving vacation where some trips start on November 27, while other trips start on November 28, etc., and the trips do not necessarily have the same destination (e.g., Hawaii, Costa Rica, Bermuda, etc.). This allows a user to compare a variety of options that seem unrelated but can share an overlapping primary parameter or feature (e.g., all trips involve travel on or around a particular day or date range).

Manage Multiple Trips.

Users will be able to go to a multiple trip view page on their trips board. There the user will be able to access each individual trip they are involved with as well as manage those individual trips. Further the user will see any new action that happened related to the specific trips.

Fare Alert Process.

Users can create a new trip. The system is configurable so that fare alerts are automatically sets-up in the database on its server as well as with one or more third party site partners. In other configurations, the fare alerts can be generated in response to a user accessing a group of pinned or marked travel products. The system then automatically or semi-automatically receives fare alert information from one or more third party sites in response to the inquiry. The system can then communicate the changes in fares and/or availability to one or more specific users.

Fare or Deal Promotion Process.

An airline, for example, can send information regarding a travel deal or promotion to the server. The system is then configurable to process the information received from the airline or travel provider and communications the information to one or more specific users based on the current configuration of the travel products being managed by the user on their password protected platform.

A fare or deal promotion process can be directed to an individual traveler. Thus, an airline, for example, can send information pertaining to a deal or sale to the system, the system is configurable to then process the information, and then communicates the information to one or more users.

Creation of Groups.

The system allows users to create groups that will inculde travelers and guests. This enable users to invite a group to a specific trip and automatically set the numbers of travelers as well as their information in the new trip.

Travel Groups.

The platform enables user to create travel groups. Travel groups can be a group of predefined users that belong to a group. A user can set up such a group, by creating a group and adding users to that group. Users that can be added can be independent users or users that have been created in that specific group. Once a group has been created, the user can easily add a group to a specific board. All people from that group will automatically be added to the trip, and be notified they have been added.

Points.

The platform can also enable users to compare options to purchase with points/miles. While searching for travel options with points/miles not bounded by destination and date, users will be able to bookmark them to their tripboard. On the tripboard they will be able to compare all options. Further, user can also compare on one page travel options with points/miles and travel options for purchase.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-readable medium having computer executable instructions comprising:
collecting from a computing device one or more primary parameters;
generating a search result on a third party platform which provides one or more results which contain the one or more primary parameters collected,
generating a visual marker within the third party platform at each of the one or more search results wherein the visual marker is capable of communicating with the tripboard;
receiving a selection of one or more results from the third party website wherein the one or more selected results is accessible by the computing device; and
creating a category accessible by the computing device in response to the one or more selected results.

2. The computer-readable medium having computer executable instructions of claim 1 further comprising refreshing a time variable parameter of the one or more selected results when the category is accessed from the computing device.

3. The computer-readable medium having computer executable instructions of claim 2 further comprising the step of communicating one or more refreshed results to another user having access to the category.

4. The computer-readable medium having computer executable instructions of claim 1 further comprising, from the third party website accessing a subsequent third party website and generating a subsequent search result from the one or more primary parameters without collecting additional parameters.

5. The computer-readable medium having computer executable instructions of claim 1 further comprising generating one or more targeted advertisements within a category based on the one or more parameters of the selected items within the category.

6. The computer-readable medium having computer executable instructions of claim 1 further comprising determining whether a plugin has been installed on the computing device.

7. The computer-readable medium having computer executable instructions of claim 6 further comprising prompting a user to install the plugin if a plugin has not been installed.

8. The computer-readable medium having computer executable instructions of claim 1 further comprising requesting a secondary user to access the category accessible via the computing device wherein the category has one or more selected items.

9. The computer-readable medium having computer executable instructions of claim 8 wherein one or more of category and the selected items has a comment section.

10. The computer-readable medium having computer executable instructions of claim 8 wherein the user and the secondary user can communicate in real-time.

11. The computer-readable medium having computer executable instructions of claim 8 wherein communication can occur between one or more secondary users.

12. The computer-readable medium having computer executable instructions of claim 1 further comprising purchasing an item from a third party website.

13. The computer-readable medium having computer executable instructions of claim 12 wherein the item purchased is one of a marked item marked in the category and an item having one or more primary parameters.

14. The computer-readable medium having computer executable instructions of claim 1 wherein the one or more primary parameters is selected from the group comprising: origination location, destination location, date, user preferences, price parameter, and target third party website.

15. The computer-readable medium having computer executable instructions of claim 1 further comprising providing one or more non-pinned travel products which include the one or more primary parameters.

16. The computer-readable medium having computer executable instructions of claim 1 further comprising the step of at least one of sorting and filtering the selection of one or more results from the third party websites by one or more of price, date, carrier, destination, and availability.

17. A method of organizing trip itineraries from a plurality of third party websites comprising:
collecting from a computing device one or more primary parameters;
generating a search result on a third party website which provides one or more results which contain the one or more primary parameters collected,
generating a visual marker within the third party website at each of the one or more search results wherein the visual marker is capable of communicating with the dashboard installed on the computing device;
receiving a selection of one or more results from the third party website wherein the one or more selected results is accessible by the computing device; and
creating a category accessible by the computing device in response to the one or more selected results.

18. The method of claim 17 further comprising refreshing a time variable parameter of the one or more selected results when the category is accessed from the dashboard on the computing device.

19. The method of claim 17 further comprising, from the third party website accessing a subsequent third party website and generating a subsequent search result from the one or more primary parameters without collecting additional parameters.

20. The method of claim 17 further comprising generating one or more targeted advertisements within a category based on the one or more parameters of the selected items within the category.

21. The method of claim 17 further comprising requesting a secondary user to access the category accessible via the dashboard of the computing device having one or more selected items.

22. The method of claim 17 further comprising purchasing a marked item from a third party website via the dashboard.

23. The method of claim 17 wherein the one or more primary parameters is selected from the group comprising: origination location, destination location, start date, end date, user preferences, price parameter, and target third party website.

24. The method of claim 17 further comprising providing one or more non-pinned itineraries which include the one or more primary parameters.

25. A computing device comprising:
a processor;
a storage medium for tangibly storing thereon program logic for execution by the processor, the program logic comprising:
collecting from a computing device one or more primary parameters;
generating a search result on a third party website which provides one or more results which contain the one or more primary parameters collected,
generating a visual marker within the third party website at each of the one or more search results wherein the visual marker is capable of communicating with the dashboard installed on the computing device;
receiving a selection of one or more results from the third party website wherein the one or more selected results is accessible by the computing device; and
creating a category accessible by the computing device in response to the one or more selected results.

26. The computing device of claim 25 further comprising refreshing a time variable parameter of the one or more selected results when the category is accessed from the dashboard on the computing device.

27. The computing device of claim 25 further comprising, from the third party website accessing a subsequent third party website and generating a subsequent search result from the one or more primary parameters without collecting additional parameters.

28. The computing device of claim 25 further comprising generating one or more targeted advertisements within a category based on the one or more parameters of the selected items within the category.

29. The computing device of claim 25 further comprising requesting a secondary user to access the category accessible via the dashboard of the computing device having one or more selected items.

30. The computing device of claim 25 further comprising purchasing a marked item from a third party website via the dashboard.

31. The computing device of claim 25 wherein the one or more primary parameters is selected from the group comprising: origination location, destination location, start date, end date, user preferences, price parameter, and target third party website.

32. The computing device of claim 25 further comprising providing one or more non-pinned itineraries which include the one or more primary parameters.

33. A method of providing demand data comprising:
collecting from one or more computing devices one or more primary parameters;
generating one or more search results on one or more third party websites which provide one or more selectable items which contain the one or more primary parameters collected;
receiving a selection by one or more users of one or selectable items from the search results;
aggregating the one or more selectable items for the one or more users; and
determining a demand for one or more selectable items.

34. The method of providing demand data of claim 33 wherein the step of determining demand further comprises receiving and analyzing user response to a price change.

35. The method of providing demand data of claim 33 the step of determining demand further comprises analyzing user comments within a tripboard.

36. The method of providing demand data of claim 33 the step of predicting demand for a travel product.
